(19) United States
(12) Patent Application Publication
(10) Pub. No.: US 2014/0052582 A1
(43) Pub. Date: Feb. 20, 2014

(54) ONLINE SYSTEM FOR PERSON TO PERSON TRANSACTION

(71) Applicants: Fadl-Alla Abdel Karim, Montreal (CA); Alain Jacob, Montreal (CA)

(72) Inventors: Fadl-Alla Abdel Karim, Montreal (CA); Alain Jacob, Montreal (CA)

(21) Appl. No.: 13/955,162

(22) Filed: Jul. 31, 2013

Related U.S. Application Data
(60) Provisional application No. 61/683,608, filed on Aug. 15, 2012.

(51) Int. Cl. G06Q 30/06

(52) U.S. Cl. CPC G06Q 30/0625
USPC 705/26.62

(57) ABSTRACT

The present document describes methods and systems for matchmaking a consumer searching for a product or a service, to a provider. The present document also describes methods and systems for matchmaking a consumer searching for a product or a service, to a provider, having a traceable and verifiable identification, and within a specific geographical zone.

### CROSS-REFERENCE TO RELATED APPLICATIONS

This application claims priority under 35USC§119(e) of U.S. provisional patent application 61/683,608, filed Aug. 15, 2012, the specification of which is hereby incorporated by reference.

### BACKGROUND

(a) Field

The subject matter disclosed generally relates to method and system for matchmaking a consumer searching for a product or a service, to a provider. More specifically, the subject matter disclosed relates to method and system for matchmaking a consumer searching for a product or a service, to a provider, having a traceable and verifiable identification, and within a specific geographical zone.

(b) Related Prior Art

Web-based services for consumer to consumer interactions help consumers find specific products and services all over the world. Typically, such services will return the results of a query from one consumer looking for a product or a service, based on the available products or services matching the query. The results may be from products available worldwide, or within a desired geographical zone (e.g. a country, a state or province, a city, etc.). The consumer may then choose to purchase the product or service. These services allow consumers to obtain a certain degree of confidence that the party selling the product or offering the services are reliable and trustworthy by providing ratings of past consumers or the likes. However, these ratings do not guarantee that the transaction between the consumer purchasing the product or service and the seller/provider will be satisfyingly be concluded for each party. These services are not centered on the meeting, in the real world, of each party performing the transaction. Furthermore, the recourses provided by the services do not allow any of the party the possibility of tracking down the other party in the real world.

Therefore, there is a need for a method for matchmaking a consumer searching for a product or a service, to a provider, which allows the consumer and the provider to meet in person for the conclusion of a transaction.

Also, there is a need for a method for matchmaking a consumer searching for a product or a service, to a provider, which uses traceable and verifiable identification for the consumer and the provider.

### SUMMARY

According to an embodiment, there is provided a method of matchmaking a consumer searching for a product or a service to a provider, the method comprising:
a) communicating at least one product or service offer entry from a database accessible from a computer network from a server network device with one or more processor, the database comprising a plurality of product or service offer entries associated with at least one provider, to the consumer, for viewing by the consumer,
the at least one product or service offer entry being chosen according to:
   at least one search criteria entered by the consumer for the product or the service,
   the geographical zone associated with the consumer, and
   the at least one provider conducting business in the geographical zone; and
b) matchmaking the consumer to the provider including a communication between the consumer and the provider associated with the at least one product or service offer entry
wherein the consumer and the provider each have a traceable and verifiable identification.

The communication may comprise inquiring about the product or service offer entry, purchasing the product or the service, requesting an in person meeting with the provider, or combinations thereof.

The method may further comprise allowing the provider associated with at least one product or service offer entry to contact the consumer concerning the product or service offer entry, or for requesting an in person meeting with the consumer, or both.

The requesting an in person meeting may be by selecting an open period of time provided by the provider or by the consumer.

The in person meeting may be for purchase and exchange of the product or the service.

The method may further comprise communicating a notification from the server network device to a client network device associated with the consumer.

The notification may be chosen from a periodic electronic reminder, an additional product or service offer entry, or combinations thereof.

The periodic electronic reminder may comprise previously communicated product or service offer entry, a summary of the at least one search criteria entered by the consumer for the product or the service, or combinations thereof.

The additional product or service offer entry may comprise an entry concerning a popular product or service, a new product or service offer entry, an old product or service offer entry, a product or service offer entry similar or related to previous product or service offer entry purchased or searched for by the consumer, or combinations thereof.

The geographical zone associated with the consumer may be adjustable.

The geographical zone associated with the consumer may be enlargeable to obtain a greater number of product or service offer entry.

The geographical zone associated with the consumer may be reducible to obtain a smaller number of product or service offer entry.

The method may further comprise shipping of the product to the consumer.

The shipping may be by the provider.

The traceable and verifiable identification may be an electronic contact information provided by an employer, a school, or an internet service provider, that is verifiable and/or is verified by contacting the employer, school, or internet service provider.

The electronic contact information may be an email address.

The traceable and verifiable identification may further comprise a photograph of the consumer or the provider.

The electronic contact information may comprise information provided by the employer about the consumer or the provider.

In the method of the present invention the consumer may further comprise a consumer rating for providing the provider with a reliability assessment of the consumer.

In the method of the present invention, the provider may further comprise a provider rating for providing the consumer with a reliability assessment of the provider.

The product may comprise books, phones, a portable phone, a computer, a portable computer, a car, and course notes.

The service may comprise a carpooling, a house rental, an apartment rental, a roommate search, a course tutoring, and an employment offer.

In the method of the present invention, wherein after contacting the provider associated with a product or service offer entry, the consumer may include the provider associated with a product or service offer entry on a listing of trusted provider.

In the method of the present invention, wherein after contacting the consumer, the provider associated with a product or service offer entry may include the consumer on a listing of trusted consumer.

The method may further comprise the consumer or the provider adding a friend on a listing of trusted friend.

According to another embodiment, there is provided a system for matchmaking a consumer searching for a product or a service to a provider, comprising:
a database accessible from a computer network from a database server with one or more processor, comprising
a user database containing user information for each of a user of the system, wherein the user is a consumer, a provider, or a combination thereof,

the user information comprising
a traceable and verifiable identification associated with the user,
a geographical zone associated with the consumer, and
a geographical zone where the provider conducts business,
a product or service database comprising a plurality of product or service offer entries associated with at least one provider,
a desired product or service database comprising a plurality of product or service query comprising

at least one search criteria entered by the consumer, for a product or a service, and

the geographical zone associated with the consumer;
a data-processor for matching the product or service query to the product or service offer entry and the geographical zone where the provider conducts business; and
an interface server, providing an interface between the system and a user's client network device, the interface server being operable to:
communicate with the database server,
receiving the product or service offer entry from the provider,
receiving the product or service query from a consumer,
transmitting the product or service offer entry to the consumer,
receiving and transmitting a communication between the consumer and the provider, and
presenting the user with the product or service offer entry, the communications.

The communication comprises inquiring about the product or service offer entry, purchasing the product or the service, requesting an in person meeting with the provider, or combinations thereof.

The user information may further comprise a listing of open time period provided by the user.

The communication may be for requesting an in person meeting by selecting an open period of time provided by the user.

The system may be operable to send a notification to a client network device associated with the consumer.

The notification may be chosen from a periodic electronic reminder, an additional product or service offer entry, or combinations thereof.

The periodic electronic reminder comprises previously communicated product or service offer entry, a summary of the at least one search criteria entered by the consumer for the product or the service, or combinations thereof.

The additional product or service offer entry may comprise an entry concerning a popular product or service, a new product or service offer entry, an old product or service offer entry, a product or service offer entry similar or related to previous product or service offer entry purchased or searched for by the consumer, or combinations thereof.

The geographical zone associated with the consumer may be adjustable.

The geographical zone associated with the consumer may be enlargeable to obtain a greater number of product or service offer entry.

The geographical zone associated with the consumer may be reducible to obtain a smaller number of product or service offer entry.

The geographical zone where the provider conducts business may be adjustable.

The geographical zone where the provider conducts business may be enlargeable to reach a greater number of consumer.

The geographical zone where the provider conducts business may be reducible to reach a smaller number of consumer.

The traceable and verifiable identification may be an electronic contact information provided by an employer, a school, or an internet service provider, that is verifiable and/or is verified by contacting the employer, school, or internet service provider.

The electronic contact information may be an email address.

The traceable and verifiable identification may further comprise a photograph of the consumer or the provider.

The electronic contact information may comprise information provided by the employer about the consumer or the provider.

The user information may further comprise a consumer rating for providing the provider with a reliability assessment of the consumer.

The user information may further comprise a provider rating for providing the consumer with a reliability assessment of the provider.

The system may be operable to receive a request from the consumer to include the provider associated with a product or service offer entry on a listing of trusted provider.

The system may be operable to receive a request from provider to include the consumer on a listing of trusted consumer.

The consumer or the provider may add a friend on a listing of trusted friends.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1A-B illustrate a diagrammatic representation of a method according to embodiments of the present invention.

FIG. 2 illustrates a diagrammatic representation of a system according to one embodiment of the present invention.

FIG. 3 illustrates a diagrammatic representation of a method according to one embodiment of the present invention.

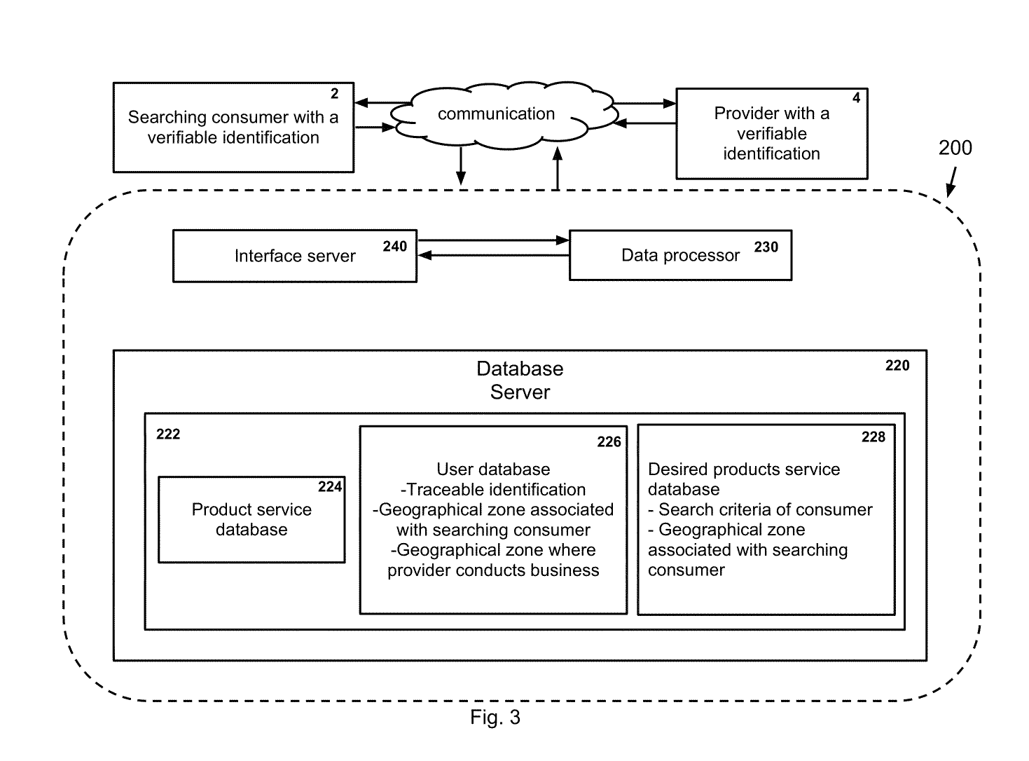

FIG. 4 illustrates an interface of a system according to one embodiment of the present invention.

FIG. 5 illustrates an interface of a system according to one embodiment of the present invention.

FIG. 6 illustrates an interface of a system according to one embodiment of the present invention.

FIG. 7 illustrates an interface of a system according to one embodiment of the present invention.

FIGS. 8A-F illustrate an interface of a system according to one embodiment of the present invention.

FIGS. 9A-C illustrate an interface of a system according to one embodiment of the present invention.

FIGS. 10A-B illustrate an interface of a system according to one embodiment of the present invention.

FIGS. 11A-H illustrate an interface of a system according to one embodiment of the present invention.

FIGS. 12A-G illustrate an interface of a system according to one embodiment of the present invention.

FIGS. 13A-J illustrate an interface of a system according to one embodiment of the present invention.

FIGS. 14A-C illustrate an interface of a system according to one embodiment of the present invention.

It will be noted that throughout the appended drawings, like features are identified by like reference numerals.

### DETAILED DESCRIPTION

In a first embodiments there is disclosed a method of matchmaking a consumer searching for a product or a service to a provider.

In a second embodiment, there is disclosed a system for matchmaking a consumer searching for a product or a service to a provider.

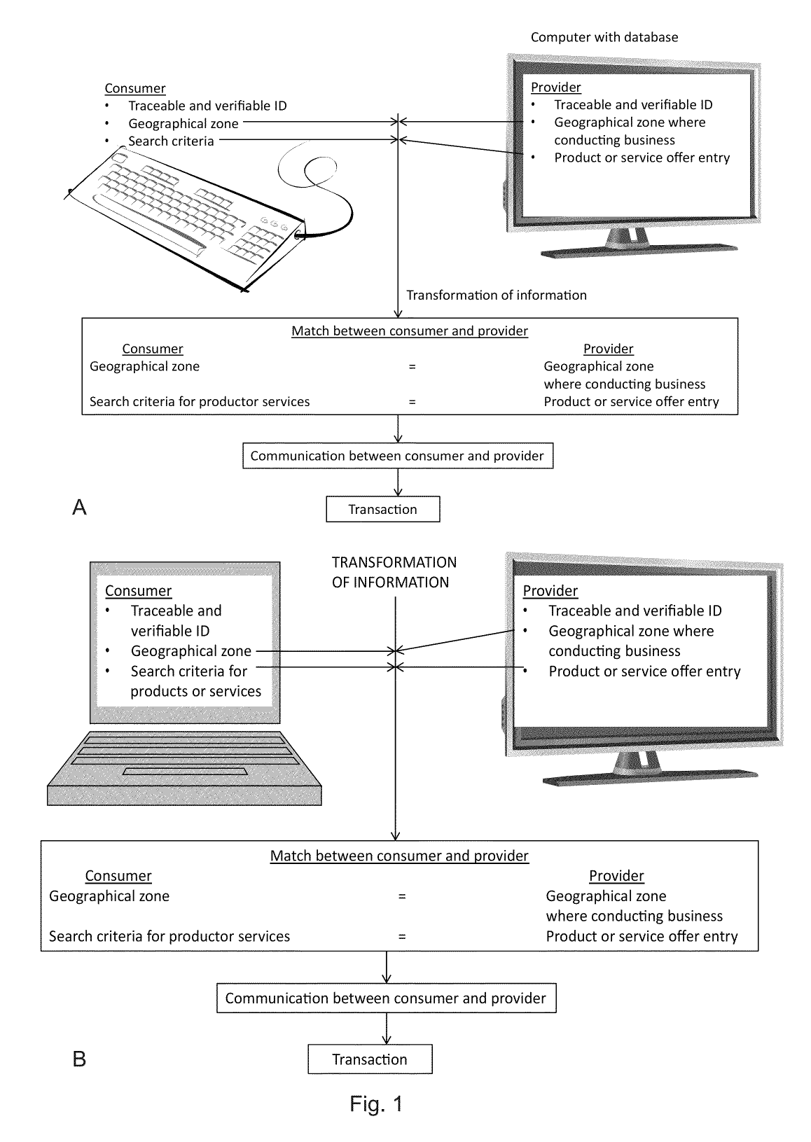

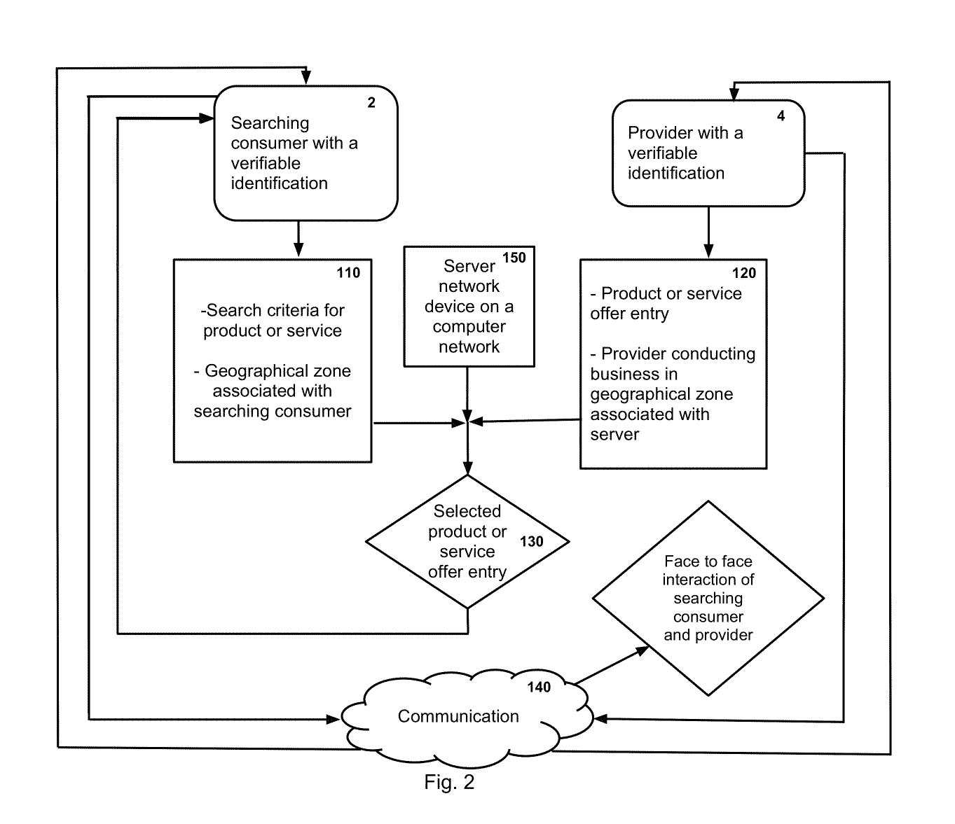

Now referring to FIG. 1-2, according to the first embodiment, in the method of matchmaking a consumer (2) searching for a product or a service to a provider (4) of the present invention, the consumer (2) and the provider (4) each have a traceable and verifiable identification. For example, the traceable and verifiable identification is information which is provided by an employer, a school, or an internet service provider, or any entity that is verifiable and/or that can be verified by contacting it. For example, each of the employer, school, internet service providers, or entity may contact or may be contacted to have the traceable and verifiable information traced or verified by an authorized person or entity. For example, such authorized entity may include an administrator of an entity practicing the method of the present invention, or law enforcement agencies desiring to identify the consumer or the provider in the course of their activity. The traceable and verifiable identification may be an electronic contact information, such as for example an email address, a permanent IP address, or any other comparable electronic contact information.

According to another embodiment, the traceable and verifiable identification may also comprise a photograph of the consumer or the provider. For example, the consumer or the provider may upload a photograph to his profile so that when people are going to meet, they are capable of visually indentify the person that they are going to meet. This is another manner in which less fraud and more security can be achieved in the method of the present invention, by letting people know who they are going to meet.

According to another embodiment, in situations where the consumer or the provider do not work for companies providing them with email addresses, and they do not have access to a verifiable email address with a verifiable internet service provider for example, these consumer or the provider can be accommodated by having an authorized representative of their small company or store provide the electronic contact information about their employees who work in the store create on a page available from the profile of the consumer or the provider. For example, this electronic contact information about their employees could be made available on a webpage for the small company or store, accessible to consumers or provider. In other words, an authorized representative of the small company or store could create their own company page, and all the employees would link their accounts to this page as their electronic contact information in order to access the website. Therefore the security of the transactions is still maintained since an employee of a small company or store would be linked to the homepage of the small company or store where he/she works, thus allowing for a traceable account if anything happens.

Therefore, according to an embodiment, the method comprises:

A) Communicating to the consumer (2), at least one product or service offer entry from a database accessible from a computer network from a server network device (150) with one or more processor. According to one embodiment, the database comprises a plurality of product or service offer entries, which are associated with at least one provider (4), and preferably a plurality of provider. The product or service offer entries are then viewed by the consumer (2) on his personal network access device (such as a personal computer, a cell phone, a tablet, or the likes).

The product or service offer entry or entries are chosen according to at least one search criteria entered by the consumer (2) for the product or the service, the geographical zone associated with the consumer (both of which are referred as 110 in FIG. 1), and the at least one provider (4) conducting business in the geographical zone that is associated with the consumer. A match is made between the search criteria entered by the consumer (2) and his associated geographical zone (110), and the product or service offer entry associated with the provider (4) and the geographical zone in which the provider (4) conducts business (120).

According to an embodiment, the consumer (2) reviews the product or service offer entries that have been provided to him on his personal network access device (such as a personal computer, a cell phone, a tablet, or the likes) and may decide to select or further pursue one or more of the product or service offer entries.

Next, according to an embodiment, the method of the present invention allows:

B) the matchmaking of the consumer (2) to the provider (4). This includes communication between the consumer and the provider associated with the product or service offer entry or entries.

According to an embodiment, the communication may comprise inquiring about the product or service offer entry, purchasing the product or the service, requesting an in person meeting with the provider, or combinations thereof. According to another embodiment, matchmaking may comprise allowing the provider (4) associated with the at least one product or service offer entry to contact the consumer (2) concerning the product or service offer entry, or for requesting an in person meeting with the consumer (2), or both.

According to an embodiment, requesting an in person meeting is by selecting an open period of time provided by the provider (4) or by the consumer. The server network device allows each of the consumer (2) and the provider (4) to provide periods of time where they are free in order to meet. For example, the period of time is for an in person meeting for purchase and exchange of the product or the service. It is believed that the fact of meeting in person put a focus on personal, face to face interactions, and allows faster and easier transaction. Also, the fact both parties are face to face is likely to minimize fraud because the persons involved in the transaction can be visually identified and be tracked down because of their traceable and verifiable identification. Furthermore, meeting in person expands the personal network of the consumer (2) or provider (4). Lastly, in person meetings can be arranged at well populated or crowded public areas within the geographical zone of the consumer, which should be inherently safer than remote locations. According to another embodiment, the in person meeting could happen at a location designated and supervised by an entity practicing the method of the present invention.

According to another embodiment, the method of the present invention may also include communicating a notification from the server network device to a client network device associated with the consumer (4). The notifications are normally sent after the initial search for product of service performed by the consumer (2); but they could also be sent as the search is being performed. Non limiting examples of notifications include periodic electronic reminder, an additional product or service offer entry, or combinations thereof. Non limiting examples of periodic electronic reminder include previously communicated product or service offer entry, a summary of the search criteria (or criterion) entered by the consumer (2) for the product or the service, or combinations thereof. Non limiting examples of additional product or service offer entry comprises an entry concerning a popular product or service (such as “trending” items or services), a new product or service offer entry (e.g. that has been added after the original search), an old product or service offer entry, a product or service offer entry similar or related to previous product or service offer entry purchased or a product or service offer entry similar or related to a product or service searched for by the consumer (2), or combinations thereof.

According to an embodiment, the geographical zone associated with the consumer is a zone where the person desires to search for product or services. As used herein, the term geographical zone associated with the consumer is intended to mean any geographical zone where the consumer (2) would be willing to identify a product or service offer and travel to acquire the product or service, or pay for shipping of the product or service to him or her. According to some embodiments, it may be a neighbourhood (e.g. the downtown area) or several neighbourhoods, or areas of a city, an entire city, a city and surrounding region, one, two, three or more cities, a state, a province, a country, a continent, or the world. Although, in practical terms, a preferred geographical zone should be as small as practically useful in order to identify products or services, and travel to collect them, it may be envisioned that some consumers (2) would be willing to travel larger distances to obtain some prized products or services.

Therefore, according to some embodiments, the geographical zone associated with the consumer may be adjustable. For example, according to one embodiment, the geographical zone associated with the consumer (2) may be enlargeable to obtain a greater number of product or service offer entry. According to another embodiment, the geographical zone associated with the consumer (2) may be reducible to obtain a smaller number of product or service offer entry.

According to another embodiment, the provider (4) is also associated with a geographical zone, in which the provider (4) conducts business. According to the present invention, the product or service offers provided to the consumer are selected by the server network device based on the overlap of the search criteria (criterion) and of the geographical zone associated with the consumer (2) and the geographical zone, in which the provider (4) conducts business. As used herein, and similarly to the geographical zone associated with the consumer (2), the term geographical zone in which the provider (4) conducts business is intended to mean any geographical zone where the provider (4) would be willing to provide his product or service offer and travel to provide the product or service, or ship the product or service. According to some embodiments, it may be a neighbourhood (e.g. the downtown area) or several neighbourhoods, or areas of a city, an entire city, a city and surrounding region, one, two, three or more cities, a state, a province, a country, a continent, or the world. Although, in practical terms, a preferred geographical zone should be as small as practically useful in order to provide products or services, and travel to provide them, it may be envisioned that some provider (4) would be willing to travel larger distances to provide some prized products or services.

Therefore, according to some embodiments, the geographical zone where the provider conducts business may be adjustable. For example, the geographical zone where the provider (4) conducts business may be enlargeable to reach a greater number of consumer (2), or it may be reducible to reach a smaller number of consumer (2).

According to another embodiment, the method of the present invention may also comprise shipping of the product to the consumer (2). The shipping may be by the provider (4).

According to another embodiment, in the method of the present invention the consumer (2) may further comprise an associated consumer rating for providing the provider (4) with a reliability assessment of the consumer (2). Similarly, according to another embodiment, the provider (4) may further comprise an associated provider rating for providing the consumer with a reliability assessment of the provider.

The method of the present invention may be used for the sale of any possible product, comprising for example books, phones, portable phones, computers, portable computers, cars, course notes, etc. Services may comprise carpooling, house rental, apartment rental, roommate searches, course tutoring, employment offer, etc.

According to another embodiment of the present invention, after contacting the provider (4) associated with a product or service offer entry, the consumer (2) may include the provider (4) associated with a product or service offer entry on a listing of trusted provider. Similarly, according to another embodiment, after contacting the consumer (2), the provider (4) associated with a product or service offer entry includes the consumer (2) on a listing of trusted consumer. According to another embodiment, the consumer or provider may add a friend or acquaintance on a listing of trusted friend. In this fashion, the consumer (2) and the provider (4) may build a personal network or listings containing the individuals with which they successfully conducted business or wish to conduct business with. This network and/or listings makes it easier for the consumer and/or provider to keep track of new merchandise and items being posted for sale or for requests for items to be bought.

Now referring to FIG. 2, according to a second embodiment, there is disclosed a system (200) for matchmaking a consumer (2) searching for a product or a service to a provider (4).

The system comprises:

a database (220) accessible from a computer network from a database server with one or more processor, comprising:
a user database (226) containing user information for each of a user of the system (200). The user is either a consumer, a provider, or a combination thereof. The user information comprises 1) a traceable and verifiable identification associated with the user (2) a geographical zone associated with the consumer, and 3) a geographical zone where the provider conducts business.

According to the second embodiment, in the system for matchmaking a consumer (2) searching for a product or a service to a provider (4) of the present invention, the consumer (2) and the provider (4) each have a traceable and verifiable identification. For example, the traceable and verifiable identification is information which is provided by an employer, a school, or an internet service provider, or any entity that is verifiable and/or that can be verified by contacting it. For example, each of the employer, school, internet service providers, or entity may contact or may be contacted to have the traceable and verifiable information traced or verified by an authorized person or entity. For example, such authorized entity may include an administrator of an entity practicing the method of the present invention, or law enforcement agencies desiring to identify the consumer or the provider in the course of their activity. The traceable and verifiable identification may be an electronic contact information, such as for example an email address, a permanent IP address, or any other comparable electronic contact information.

According to another embodiment, the traceable and verifiable identification may also comprise a photograph of the consumer or the provider. For example, the consumer or the provider may upload a photograph to his profile so that when people are going to meet, they are capable of visually indentify the person that they are going to meet. This is another manner in which less fraud and more security can be achieved in the method of the present invention, by letting people know who they are going to meet.

According to another embodiment, in situations where the consumer or the provider do not work for companies providing them with email addresses, and they do not have access to a verifiable email address with a verifiable internet service provider for example, these consumer or the provider can be accommodated by having an authorized representative of their small company or store provide the electronic contact information about their employees who work in the store create on a page available from the profile of the consumer or the provider. For example, this electronic contact information about their employees could be made available on a webpage for the small company or store, accessible to consumers or provider. In other words, an authorized representative of the small company or store could create their own company page, and all the employees would link their accounts to this page as their electronic contact information in order to access the website. Therefore the security of the transactions is still maintained since an employee of a small company or store would be linked to the homepage of the small company or store where he/she works, thus allowing for a traceable account if anything happens.

According to an embodiment, the geographical zone associated with the consumer is a zone where the person desires to search for product or services. As used herein, the term geographical zone associated with the consumer is intended to mean any geographical zone where the consumer (2) would be willing to identify a product or service offer and travel to acquire the product or service, or pay for shipping of the product or service to him or her. According to some embodiments, it may be a neighbourhood (e.g. the downtown area) or several neighbourhoods, or areas of a city, an entire city, a city and surrounding region, one, two, three or more cities, a state, a province, a country, a continent, or the world. Although, in practical terms, a preferred geographical zone should be as small as practically useful in order to identify products or services, and travel to collect them, it may be envisioned that some consumers (2) would be willing to travel larger distances to obtain some prized products or services.

Therefore, according to some embodiments, the geographical zone associated with the consumer may be adjustable. For example, according to one embodiment, the geographical zone associated with the consumer (2) may be enlargeable to obtain a greater number of product or service offer entry. According to another embodiment, the geographical zone associated with the consumer (2) may be reducible to obtain a smaller number of product or service offer entry.

According to another embodiment, the provider (4) is also associated with a geographical zone, in which the provider (4) conducts business. According to the present invention, the product or service offers provided to the consumer are selected by the server network device based on the overlap of the search criteria (criterion) and of the geographical zone associated with the consumer (2) and the geographical zone, in which the provider (4) conducts business. As used herein, and similarly to the geographical zone associated with the consumer (2), the term geographical zone in which the provider (4) conducts business is intended to mean any geographical zone where the provider (4) would be willing to provide his product or service offer and travel to provide the product or service, or ship the product or service. According to some embodiments, it may be a neighbourhood (e.g. the downtown area) or several neighbourhoods, or areas of a city, an entire city, a city and surrounding region, one, two, three or more cities, a state, a province, a country, a continent, or the world. Although, in practical terms, a preferred geographical zone should be as small as practically useful in order to provide products or services, and travel to provide them, it may be envisioned that some provider (4) would be willing to travel larger distances to provide some prized products or services.

Therefore, according to some embodiments, the geographical zone where the provider conducts business may be adjustable. For example, the geographical zone where the provider (4) conducts business may be enlargeable to reach a greater number of consumer (2), or it may be reducible to reach a smaller number of consumer (2).

In embodiment, the system (200) also comprises a product or service database (222) which comprises a plurality of product or service offer entries associated with at least one provider (4), and preferably a plurality of provider (4).

In embodiment, the system (200) also comprises a desired product or service database (228) comprising a plurality of product or service query which include 1) at least one search criteria entered by the consumer (2), for a product or a service, and the geographical zone associated with the consumer.

The system also includes a data-processor (230) for matching the product or service query to the product or service offer entry and the geographical zone where the provider conducts business; and an interface server (240), providing an interface between the system and a user's client network device. The interface server is operable to:
communicate with the database server (220),
receiving the product or service offer entry from the provider (4),
receiving the product or service query from a consumer (2),
transmitting the product or service offer entry to the consumer (2),
receiving and transmitting a communication between the consumer (2) and the provider (4), and
presenting the user with the product or service offer entry, and the communications.

According to an embodiment, the communication may comprises inquiring about the product or service offer entry, purchasing the product or the service, requesting an in person meeting with the provider, or combinations thereof.

According to an embodiment, the user information may further comprise a listing of open time period provided by the user. According to another embodiment, the communication may be for requesting an in person meeting by selecting an open period of time provided by the user. The system allows each of the consumer (2) and the provider (4) to provide periods of time where they are free in order to meet. For example, the period of time is for an in person meeting for purchase and exchange of the product or the service. It is believed that the fact of meeting in person put a focus on personal, face to face interactions, and allows faster and easier transaction. Also, the fact both parties are face to face is likely to minimize fraud because the persons involved in the transaction can be visually identified and be tracked down because of their traceable and verifiable identification. Furthermore, meeting in person expands the personal network of the consumer (2) or provider (4). Lastly, in person meetings can be arranged at well populated or crowded public areas within the geographical zone of the consumer, which should be inherently safer than remote locations. According to another embodiment, the in person meeting could happen at a location designated and supervised by an entity practicing the method of the present invention.

According to another embodiment, the system is operable to send a notification to a client network device associated with the consumer. The notifications are normally sent after the initial search for product of service performed by the consumer (2); but they could also be sent as the search is being performed. Non limiting examples of notifications include periodic electronic reminder, an additional product or service offer entry, or combinations thereof. Non limiting examples of periodic electronic reminder include previously communicated product or service offer entry, a summary of the search criteria (or criterion) entered by the consumer (2) for the product or the service, or combinations thereof. Non limiting examples of additional product or service offer entry comprises an entry concerning a popular product or service (such as “trending” items or services), a new product or service offer entry (e.g. that has been added after the original search), an old product or service offer entry, a product or service offer entry similar or related to previous product or service offer entry purchased or a product or service offer entry similar or related to a product or service searched for by the consumer (2), or combinations thereof.

According to another embodiment of the present invention, the user information may further include a consumer (2) rating for providing the provider (4) with a reliability assessment of the consumer (2). Similarly, according to another embodiment, the user information may further include a provider (4) rating for providing the consumer (2) with a reliability assessment of the provider (4).

According to another embodiment, the system of the present invention is operable to receive a request from the consumer (2) to include the provider (4) associated with a product or service offer entry on a listing of trusted provider. Similarly, according to another embodiment, the system is operable to receive a request from provider (4) to include the consumer (2) on a listing of trusted consumer. According to another embodiment, the system is operable to allow the consumer or provider to add a friend or acquaintance on a listing of trusted friend. In this fashion, the consumer (2) and the provider (4) may build a personal network or listing containing the individuals with which they successfully conducted business or wish to conduct business with. This network and/or listings makes it easier for the consumer and/or provider to keep track of new merchandise and items being posted for sale or for requests for items to be bought.

The present invention will be more readily understood by referring to the following examples which are given to illustrate the invention rather than to limit its scope.

### Example 1

### Internet Browser Based System Interface

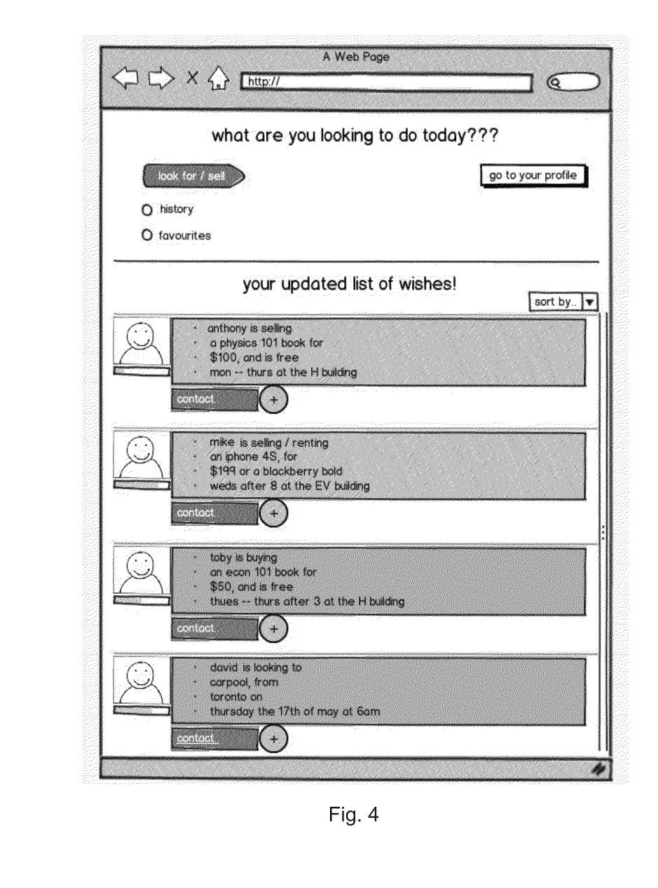

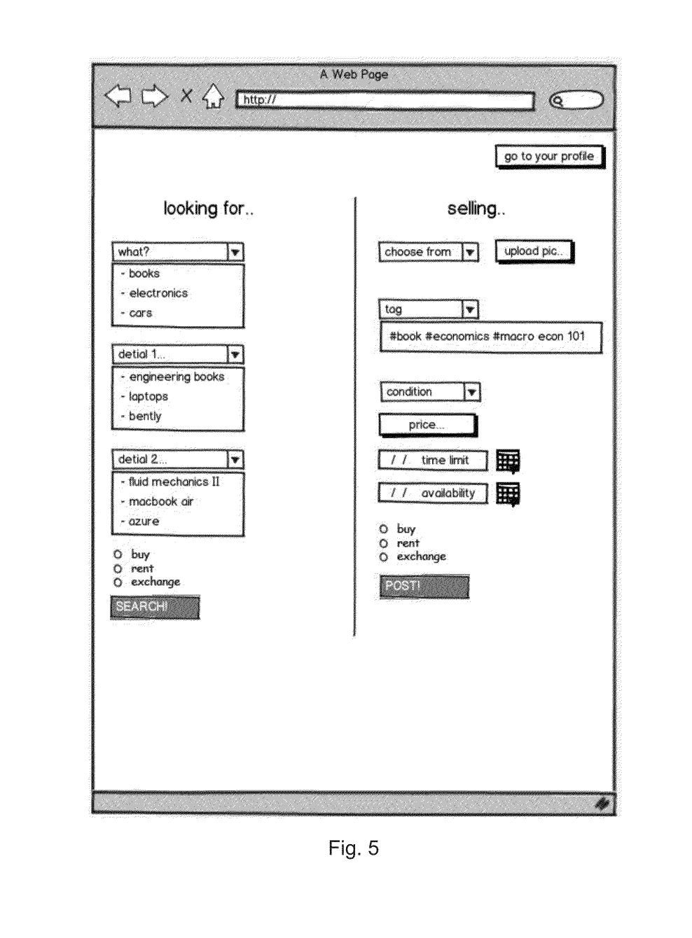

Now referring to FIGS. 4-7, there is shown an example of an internet browser based interface communicating with system according to the present invention, where a consumer contemplates a list of products or services that he or she wishes to acquire or offering for sale (FIG. 4). The consumer may also obtain access to past transaction history or to his favorites provider, from this page. According to an embodiment, FIG. 4 shows a page where the user of the system (consumer or provider) may search for products or services, and enter new products and services for sale.

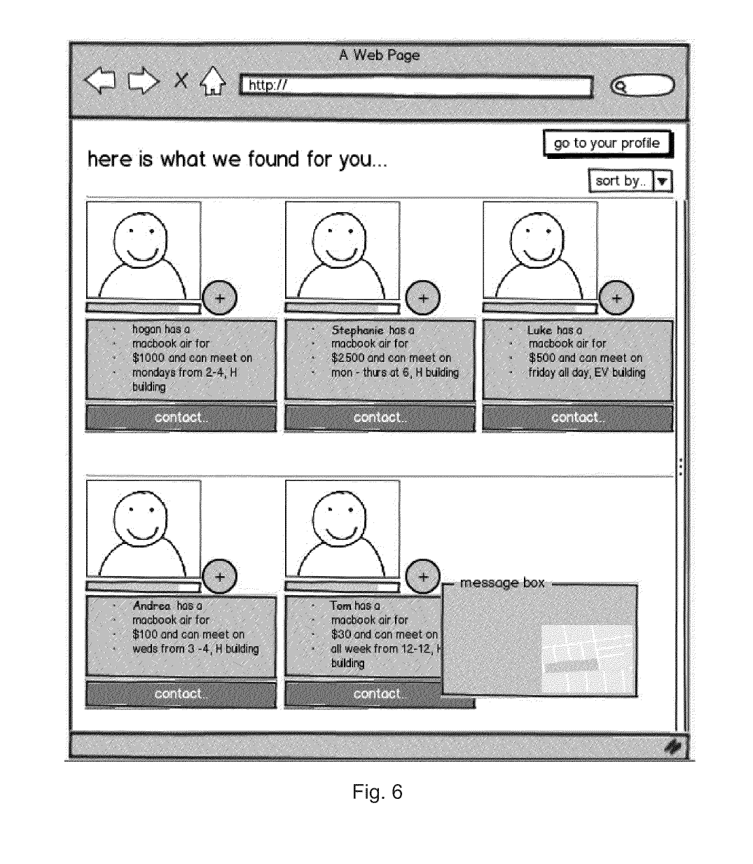

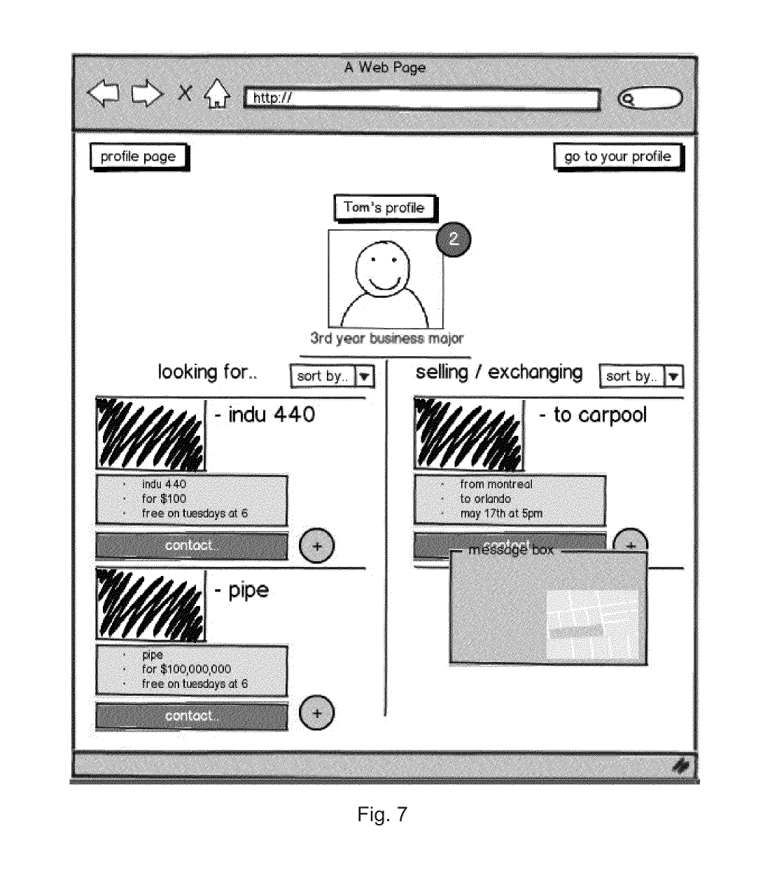

According to another embodiment, FIG. 6 shows an exemplary representation of a listing of products searched for by a consumer. FIG. 7 shows an example of a user profile according to an embodiment of the present invention, where information about the products being sold or offered for exchange, and the products being looked for by the user are displayed.

### Example 2

### Mobile Application Based System Interface

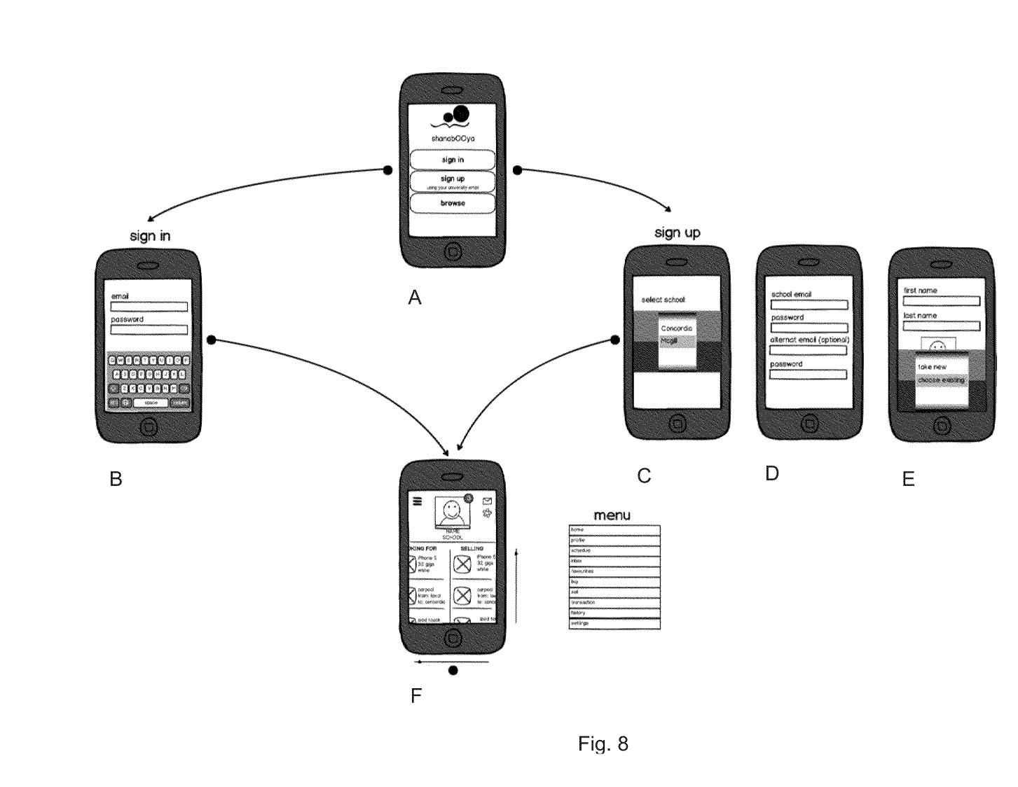

Now referring to FIG. 8A-F, there is shown an interface for a mobile application for a mobile device interfacing with a system of the present invention.

FIG. 8A shows an sig in, sign up interface page, which leads to a sign in page (FIG. 8B) where login information is requested, or a sign up page (FIGS. 8C-E) where personal traceable and verifiable information is employed to create a user account. Following sign in or sign up, the user is directed to personal user profile page where sought products and services, and offered products and services are displayed (FIG. 8F).

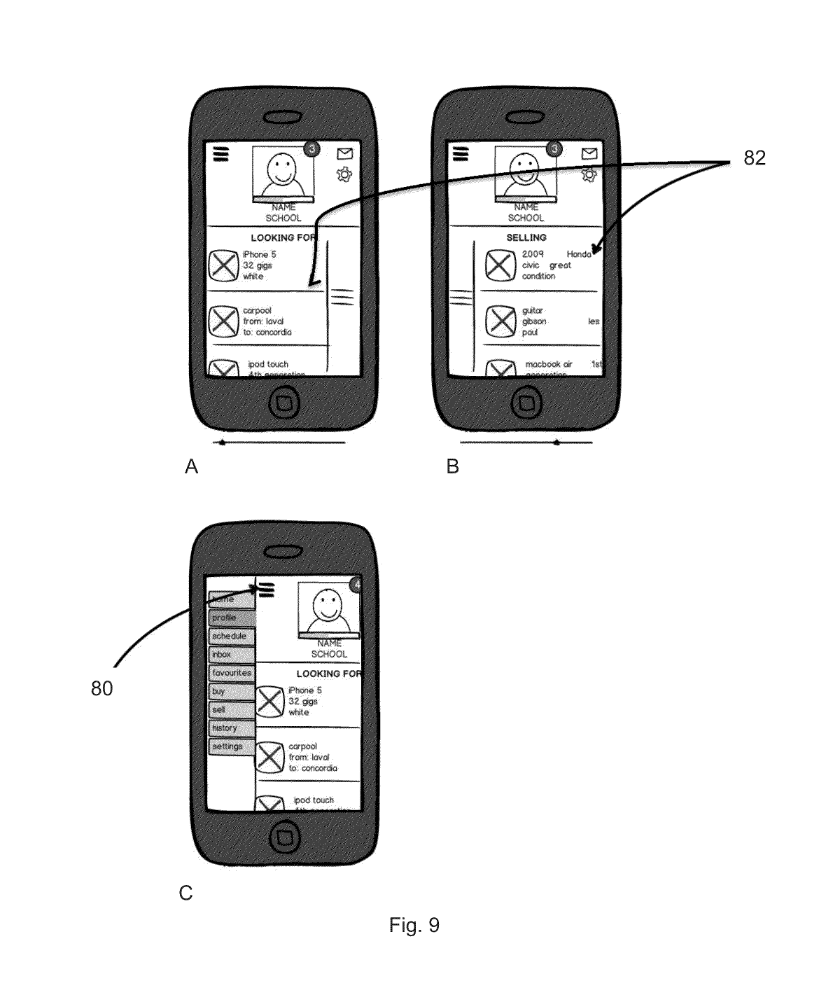

Now referring to FIGS. 9A-C, there is shown the main user profile page, where a user may see the products and services (82) sought (FIG. 9A) and offered (FIG. 9B). FIG. 9C shows a menu button (80) from which a tab panel appears to provide access to the other area of the application for using the system of the present invention.

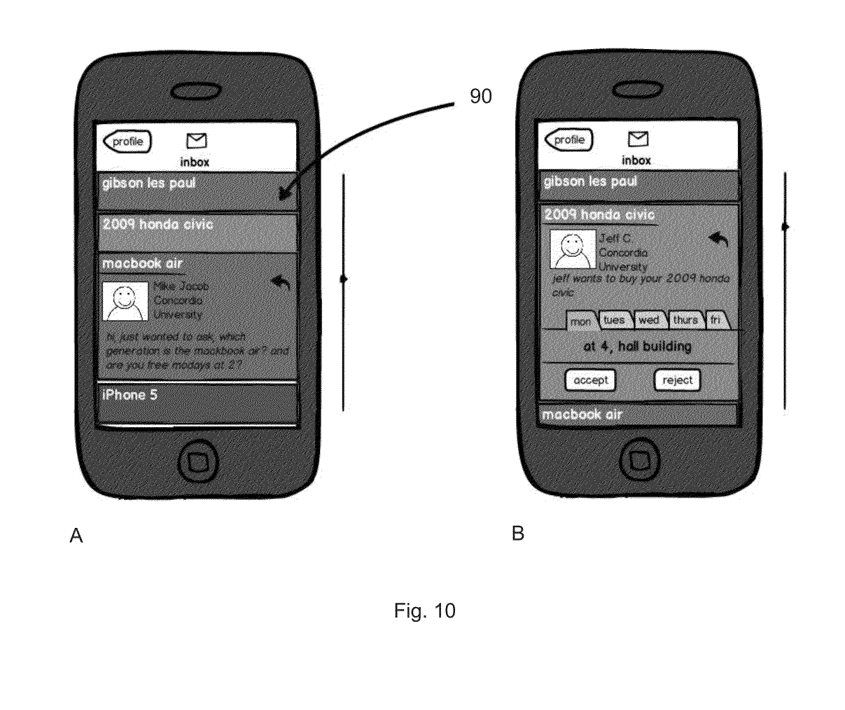

Now referring to FIG. 10A-B, there is shown a user's inbox, where communications (90) with the user from the system concerning products or services of interest to the user, or from other users (consumers and/or providers) are listed successively (FIG. 10A). According to an embodiment, selecting one such communication may provide additional details about the product or service offered for sale, such as an accepted transaction, requesting an in person meeting (FIG. 10B).

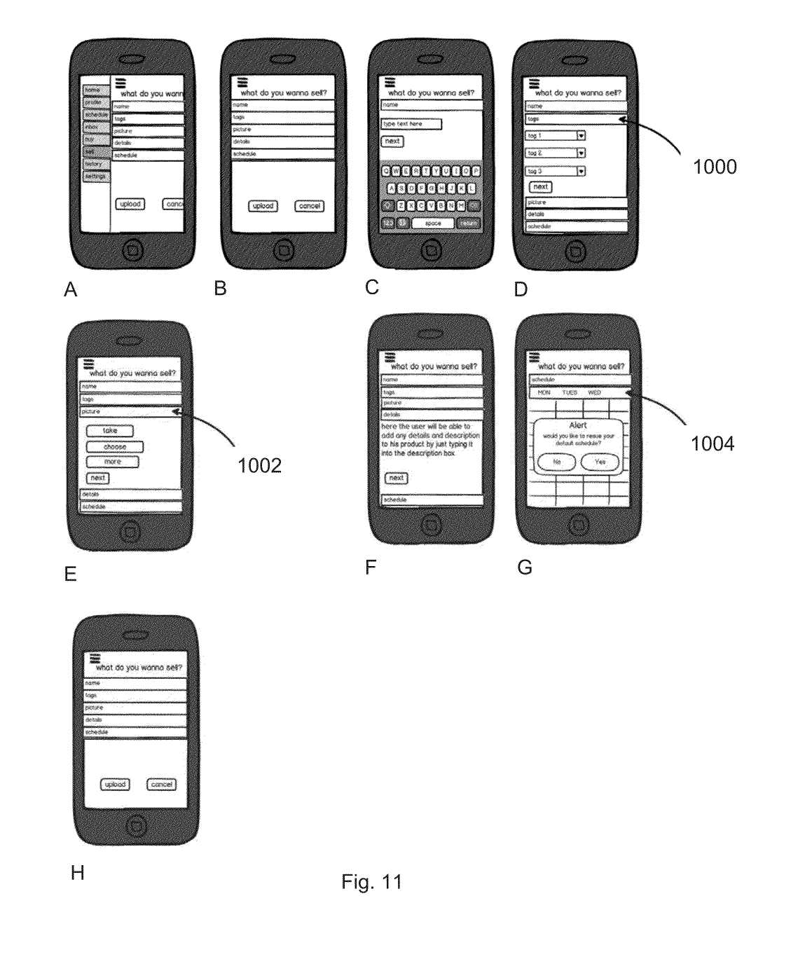

Now referring to FIGS. 11A-H, there is shown an embodiment of a provider's offer for sale interface (FIGS. 11A-D) where information about the product or service is entered. According to an embodiment, the sale interface may provide a tagging system (1000) for tagging the products or services (e.g. electronics, motor, books, tutoring, etc,), which would then expand upon further categories to refine the description of the product or service. According to another embodiment, a detailed description of the product to be sold may be entered (1002) (FIG. 11F) According to an embodiment, one or more pictures of the product may be taken (FIG. 11E). According to another embodiment, the open period of time (1004) during which the user would be available for a transaction may be entered in another screen (FIG. 11G) and finally, the user may upload the product or service offer (FIG. 11H).

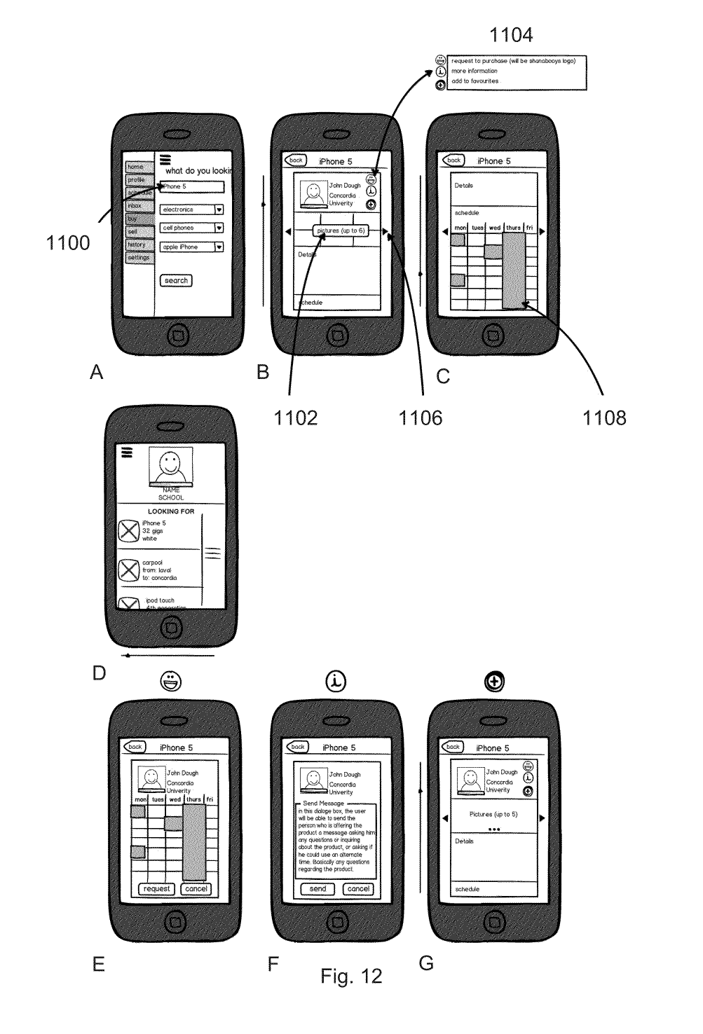

Now referring to FIGS. 12A-G, there us shown a search interface where the consumer may search for products or services offers (1100) (FIG. 12A). The consumer may select any product or service offer (1100) to obtain more details (FIG. 12B). Several pictures (1002) displayed in the offer may be viewed by swiping from left to right or vice versa (1006), and selected to see larger images. According to an embodiment, scrolling down may display the provider's schedule for a transaction (1008) (FIG. 12C). According to another embodiment, selecting the provider's picture may lead directly to the profile page of the provider, to obtain a listing of all the products and services offered by that provider, his schedule for a transaction, as well as an interface to send a communication to the provider, including any questions concerning the product of service (FIGS. 12D-G).

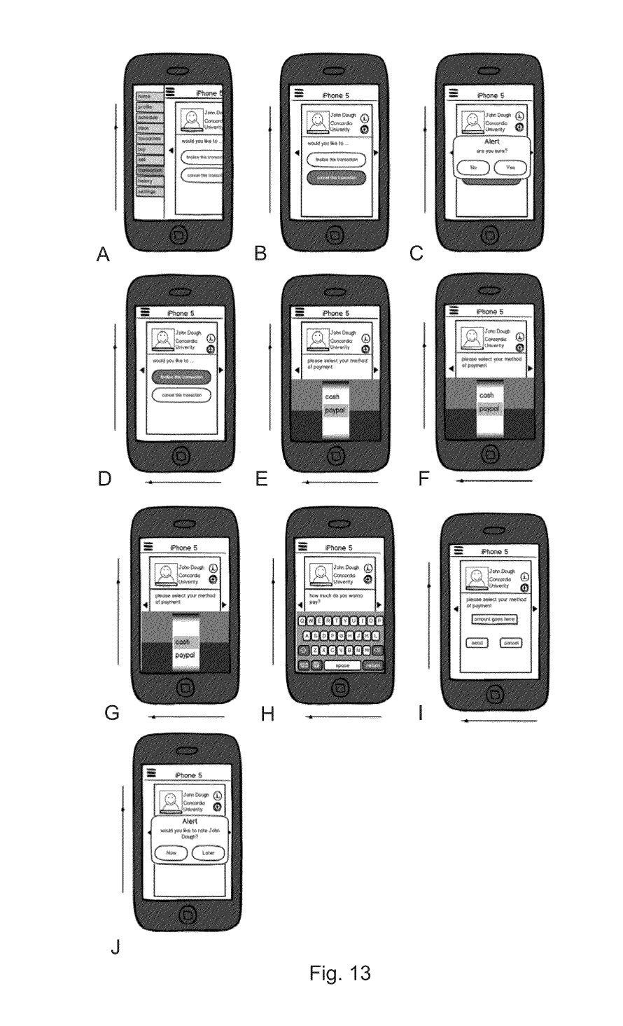

Now referring to FIGS. 13A-J, there is shown an embodiment of a transaction interface where a consumer may proceed with cancellation (FIGS. 13B-C) or completion (FIGS. D-J of a transaction for a product or service by paying using a payment service (FIGS. E-F) (e.g. paypal, a credit card, etc.) or by agreeing to pay in cash (FIGS. G-I). Finally, according to an embodiment, once a transaction has been completed, the consumer or the provider may rate the other user (FIG. J) performance concerning the transaction.

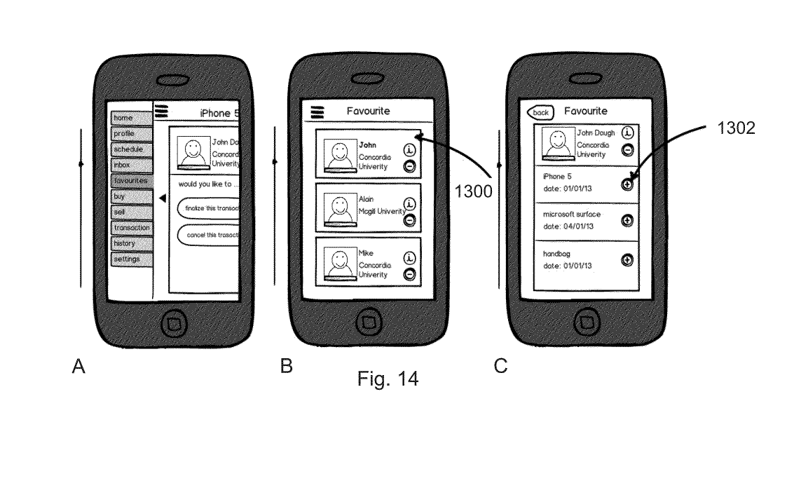

Now referring to FIGS. 14A-C, upon selecting the profile of a user, one may gain access to a detailed page of the user showing the history of the transactions (1300) that occurred between the user and other users of the system (FIG. 15B). According to another embodiment, further selecting a given transaction will show an option (1302) for getting a full history of the transaction (FIG. 14C)

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method of matchmaking a consumer and a provider comprising:
a) matching said consumer to said provider, by matching at least one search criteria entered by said consumer for a product or service offer through an interface of at least one database, along with a geographical zone associated with said consumer, to a plurality of product or service offer entries offered by at least one provider in said database, along with a geographical zone where said provider is conducting business,
said consumer and said provider both having a traceable and verifiable identification,
wherein said at least one database accessible from a computer network from a server network device with one or more processor.

2. The method of claim 1, wherein said matching comprises inquiring about said product or service offer entry, purchasing said product or said service, requesting an in person meeting with said provider, or combinations thereof.

3. The method of claim 1, further comprising allowing said provider associated with said at least one product or service offer entry to contact said consumer concerning said product or service offer entry, or for requesting an in person meeting with said consumer, or both.

4. The method of claim 2, wherein said requesting an in person meeting is by selecting an open period of time provided by said provider or by said consumer.

5. The method of claim 1, further comprising communicating a notification from said server network device to a client network device associated with said consumer.

6. The method of claim 5, wherein said notification is chosen from a periodic electronic reminder, an additional product or service offer entry, or combinations thereof.

7. The method of claim 6, wherein said periodic electronic reminder comprises previously communicated product or service offer entry, a summary of said at least one search criteria entered by said consumer for said product or said service, or combinations thereof.

8. The method of claim 6, wherein said additional product or service offer entry comprises an entry concerning a popular product or service, a new product or service offer entry, an old product or service offer entry, a product or service offer entry similar or related to previous product or service offer entry purchased or searched for by said consumer, or combinations thereof.

9. The method of claim 1, wherein said geographical zone associated with said consumer is adjustable.

10. The method of claim 9, wherein said geographical zone associated with said consumer is enlargeable to obtain a greater number of product or service offer entry.

11. The method of claim 9, wherein said geographical zone associated with said consumer is reducible to obtain a smaller number of product or service offer entry.

12. The method of claim 1, wherein said traceable and verifiable identification is an electronic contact information provided by an employer, a school, or an internet service provider, that is verifiable and/or is verified by contacting said employer, school, or internet service provider.

13. The method of claim 12, wherein said electronic contact information comprises an email address, information provided by said employer about said consumer or said provider.

14. The method of claim 12, wherein said traceable and verifiable identification further comprises a photograph of said consumer or said provider.

15. The method of claim 1, wherein said consumer further comprise a consumer rating for providing said provider with a reliability assessment of said consumer.

16. The method of claim 1, wherein said provider further comprise a provider rating for providing said consumer with a reliability assessment of said provider.

17. The method of claim 1, wherein after contacting said provider associated with a product or service offer entry, said consumer includes said provider associated with a product or service offer entry on a listing of trusted provider.

18. The method of claim 3, wherein after contacting said consumer, said provider associated with a product or service offer entry includes said consumer on a listing of trusted consumer.

19. The method of claim 1, further comprising said consumer or said provider adding a friend on a listing of trusted friend.

20. A system for matchmaking a consumer searching for a product or a service to a provider according to the method of claim 1, comprising:
at least one database accessible from a computer network from a database server with one or more processor, comprising
a user database containing user information for each of a user of said system, wherein said user is a consumer, a provider, or a combination thereof,
said user information comprising
a traceable and verifiable identification associated with said user,
a geographical zone associated with said consumer, and
a geographical zone where said provider conducts business,
a product or service database comprising a plurality of product or service offer entries associated with at least one provider,
a desired product or service database comprising a plurality of product or service query comprising
at least one search criteria entered by said consumer, for a product or a service, and
said geographical zone associated with said consumer;
a data-processor for matching said product or service query to said product or service offer entry and said geographical zone where said provider conducts business; and
an interface server, providing an interface between said system and a user's client network device, the interface server being operable to:
communicate with said database server,
receiving said product or service offer entry from said provider,
receiving said product or service query from a consumer,
transmitting said product or service offer entry to said consumer,
receiving and transmitting a communication between said consumer and said provider, and
presenting the user with said product or service offer entry, said communications.
